(19) United States
(12) Patent Application Publication
(10) Pub. No.: US 2005/0106336 A1
(43) Pub. Date: May 19, 2005

(54) Cementitious slab products having antimicrobial properties

(75) Inventors: Ivan Wei-Kang Ong, Charlotte, NC (US); Gerald W. Walker, Peterborough (GB)

Correspondence Address: KENNEDY COVINGTON LOBDELL & HICKMAN, LLP, 214 N. TRYON STREET, HEARST TOWER, 47TH FLOOR, CHARLOTTE, NC, 28202, US

(73) Assignee: MICROBAN PRODUCTS COMPANY, Huntersville, NC (US)

(21) Appl. No.: 10/989,487

(22) Filed: Nov. 16, 2004

Related U.S. Application Data
(60) Provisional application No. 60/520,799, filed on Nov. 17, 2003.

(51) Int. Cl. C09D 5/14; C04B 7/00; C04B 7/34

(52) U.S. Cl. 428/15; 106/15.05; 106/18.32; 106/18.34; 106/638; 264/71; 264/122; 264/102

(57) ABSTRACT

A composite material having the appearance of natural stone that is made from cement and natural aggregate. The composite material also has an antimicrobial material incorporated therein that resists the proliferation of microbes on the surface of the material. A method for making the composite material and a method for making a finished product from the composite material are also disclosed.

### CROSS-REFERENCE TO RELATED APPLICATION

The present application claims priority from U.S. provisional application No. 60/520,799, filed on Nov. 17, 2003, incorporated herein by reference.

### FIELD OF THE INVENTION

The invention relates to the production of a composite material suitable for forming cementitious slab products and the slab products made there from. The invention relates more particularly to a material having the appearance of marble and/or granite with improved properties including antimicrobial properties as compared to other natural or synthetic materials.

### BACKGROUND OF THE INVENTION

Polished natural stones, such as marble or granite and other igneous forms of crystalline silica or siliceous rock, are often used as decorative and functional facing and surfaces in long-lasting construction applications. However, these products require expensive handling in shaping and finishing and are only available from relatively few geographic regions. These factors significantly add to the already high cost of employing such materials.

Furthermore, every block extracted from a quarry differs, sometimes slightly and sometimes considerably, from other blocks extracted from the same quarry. Accordingly, it is almost impossible to produce floors or claddings with large surface areas which do not have aesthetic and/or color differences.

The extraction of natural stone from quarries creates a large quantity of unusable rock. Imperfections in the natural stone render it very susceptible to breakage. The blasting and rough handling of stone in quarries renders most of the stone unusable. It is estimated that the percentage of stone that is sent in the form of blocks for subsequent processing does not exceed 20-30% of the total stone that is excavated.

Several uses have been found for the large amount of waste material generated by quarries. One such use of this waste material is as a component of artificial stone products.

Artificial stone products are generally made from a mixture of a natural stone aggregate and a suitable binder. Generally speaking, there are two types of binders: polymers and cementitious binders. Using modern engineering techniques, such as those described in U.S. Pat. Nos. 6,355,191, 4,698,010, and 5,321,055, all of which are incorporated herein by reference, it is possible to achieve products that have a remarkable resemblance to natural stone. These products usually offer better color consistency than natural stone, exhibit better mechanical properties than natural stone, and cost less than natural stone.

Many of these products find use as artificial granite for flooring, walkways, and external cladding for buildings. Thus, these artificial stone products are normally found in aesthetically important areas and in close proximity to human activity. These are also areas where the growth of bacteria, mold, mildew, and fungus is highly undesirable.

These artificial stone products, although superior to natural stone in many ways, retain a problem that is inherent with natural stone. Natural stone can be quite porous and can absorb liquids that come into contact with it. If a cementitious binder is used in the making of an artificial stone product this tendency to absorb water is increased. This tendency to absorb liquid can lead to staining and water marking. The water absorbed by the stone particles also provides a moist environment suitable for growth of microorganisms that can stain the product, produce slick and dangerous surfaces, produce unwanted odors, contaminate food, act as a cross-contamination vector, and promote illness.

In short, the increased use of artificial stone products in areas of high human contact has generated a need for reducing or eliminating the potential for growth of microorganisms on the surface of the artificial stone.

### SUMMARY OF THE INVENTION

The present invention relates to a composite material suitable for forming cementitious slab products having antimicrobial properties. The composite material comprises a natural aggregate, a cementitious matrix, and an antimicrobial agent. The composite material has an appearance similar to that of natural stone yet reduces or eliminates the presence of microbes on the surface of the material.

The present invention also relates to a method of making a cementitious product having antimicrobial properties. The method comprises obtaining a natural aggregate; preparing a cementitious matrix comprising a water and cement slurry and a plasticizing additive; mixing the natural aggregate and the cementitious matrix; adding an antimicrobial agent to the aggregate and cementitious matrix; spreading the mixture of aggregate, cementitious matrix, and antimicrobial agent in a forming device; deaerating the spread mixture of aggregate, cementitious matrix, and antimicrobial agent by placing the spread mixture under a vacuum; applying a vibratory motion to the deaerated mixture while the deaerated mixture is under a vacuum; and curing the deaerated spread mixture to form a cementitious product.

It is another aspect of the present invention to form a finished product from the cementitious product.

The present invention provides such materials in a cost effective manner suitable for widespread commercial use.

### BRIEF DESCRIPTION OF THE DRAWINGS

The present invention will become more fully understood from the detailed description and the accompanying drawings, wherein:

FIG. 1 is a photograph after inoculation with a fungal species of a cementitious flooring tile sample that comprises no antimicrobial agent and offers no resistance to fungal growth.

FIG. 2 is a photograph after inoculation with a fungal species of a cementitious flooring tile sample that comprises an antimicrobial in accordance with the present invention and exhibits resistance to fungal growth.

FIG. 3 is a photograph after inoculation with a fungal species of a cementitious flooring tile sample that comprises an antimicrobial in accordance with the present invention and exhibits resistance to fungal growth.

FIG. 4 is a photograph after inoculation with a fungal species of a cementitious flooring tile sample that comprises an antimicrobial in accordance with the present invention and exhibits resistance to fungal growth.

FIG. 5 is a photograph after inoculation with a fungal species of a cementitious flooring tile sample that comprises an antimicrobial agent in accordance with the present invention but shows some signs of fungal growth.

FIG. 6 is a photograph after inoculation with a fungal species of a cementitious flooring tile sample that comprises an antimicrobial agent in accordance with the present invention but shows some signs of fungal growth.

FIG. 7 is a photograph after inoculation with a fungal species of a cementitious flooring tile sample that comprises an antimicrobial agent in accordance with the present invention but shows some signs of fungal growth.

### DETAILED DESCRIPTION OF THE INVENTION

The present invention is applicable to a variety of composites comprising natural aggregates such as marble, granite, quartz, feldspar, quartzite and mixtures thereof. Such composites are increasingly used as substitutes for solid slabs of natural stone because they are more cost effective and can be engineered to achieve specific structural and aesthetic characteristics.

As used herein, the term “natural aggregate” primarily means crushed natural stone and minerals. Specifically, the term “natural aggregate” will be understood to include aggregates comprising marble, granite, quartz, feldspar, quartzite and a mixture thereof. Likewise, the term “filler” will be understood to include materials that are often added to compositions to provide particular characteristics. Such “fillers” include fumed silica, sand, clay, fly ash, calcium carbonate, broken ceramics, mica, silicate flakes, broken glass, glass beads, glass spheres, mirror fragments, steel grit, aluminum grit, carbides, plastic beads, pelletized rubber, ground polymer composites (e.g., acrylics encasing copper filings), wood chips, sawdust, paper laminates, pigments, colorants, and a mixture thereof.

In broad terms, the invention is an improvement on a structural material having an appearance similar to natural stone. In one of the invention's most basic embodiments, it is a composite material suitable for forming cementitious slab products having an appearance similar to that of natural stone. The material comprises a natural aggregate having a predetermined and controlled particle size, a cementitious matrix, and an antimicrobial agent. The material may also comprise a plasticizer and one or more fillers.

The invention also encompasses a method for making the claimed composite material and for making products from the composite material. The claimed method is an improvement upon processes for making cementitious artificial stone. In broad terms, the claimed process comprises the steps of obtaining a natural aggregate having a predetermined particle size; preparing a cementitious matrix comprising a water and cement slurry and a quantity of a plasticizing additive; mixing the aggregate and the cementitious matrix; adding a quantity of an antimicrobial agent to the aggregate and cementitious matrix; spreading the mixture of aggregate, cementitious matrix, and antimicrobial agent in a forming device; deaerating the spread mixture of aggregate, cementitious matrix, and antimicrobial agent by placing the spread mixture under a vacuum; applying a vibratory motion to the deaerated mixture while the mixture is under a vacuum; and curing the deaerated spread mixture to form a cementitious product.

Turning now to the specifics of the claimed process, the variables inherent in artificial stone making processes (e.g., the type and quantity of natural aggregate used, the type and quantity of cementitious matrix, the use of fillers, the thickness of the end product, etc.) prevent a thorough discussion of every possible permutation of variables. However, those skilled in the art are familiar with the basic concepts of the artificial stone process and the manipulation of the various variables to achieve desired results. Accordingly, those skilled in the art are readily capable of taking the teachings of the invention described herein and modifying them and the underlying artificial stone process to achieve a desired result without undue experimentation. The following discussion is offered as an example of how the invention may be incorporated into a typical artificial stone process. The following discussion is exemplary and should not be interpreted as unduly limiting the scope of the invention.

In accordance with the present invention, composite materials are manufactured in a streamlined process. Natural aggregate of appropriate dimension, a cementitious matrix, and an antimicrobial agent are mixed and distributed in a mold and then subjected to simultaneous application of a vacuum and vibration to cause the mixture to set in a rapid and predetermined way. Each aspect of this method will now be explored in more detail.

The method according to the invention comprises obtaining a natural aggregate having a predetermined particle size. Preferred embodiments of the method also include the step of calculating the void ratio (void fraction) of the aggregate for reasons discussed below.

The natural aggregate suitable for use in the invention includes crushed natural stone and minerals. In preferred embodiments the natural aggregate is selected from the group consisting of quartz, granite, feldspar, marble, quartzite, and a mixture thereof. Marble, grarite, and quartz are particularly preferred. The size of the individual aggregate particles may vary depending upon the end use of the composite material and is ultimately limited by the size of the apparatus used. Suitable apparatus, such as those discussed in U.S. Pat. No. 6,355,191 are commercially available and will not be discussed in detail herein. In a preferred process the average size of the individual aggregate particles is kept below about 100 mm, preferably below about 25 mm, and most preferably below about 10 mm. Aggregate with an average particle size from about 0.1 mm to about 6 mm is particularly preferred.

Particle size is important to fully realize the benefits of the invention because of the unique relationship between aggregate void space and the quantity and type of cementitious matrix needed to bind the aggregate. In very general terms, too much or too little cementitious matrix will result in poor quality product that has undesirable mechanical properties. Likewise, the ratio of water to cement in the cementitious matrix should be within a desired range to provide the matrix with the fluidity necessary to fully occupy the aggregate void space. U.S. Pat. No. 6,355,191 provides a detailed discussion of this interaction between the aggregate, cement, and water and is incorporated herein by reference in its entirety. A summary of this discussion is provided as an aid to the reader.

If the starting granulated material is from the same source and is more or less homogeneous, it is preferred that the material is milled to a maximum particle size no greater than 6 mm (although, in some cases, this maximum size may reach 8 mm).

If, on the other hand, the starting granulated material is not homogeneous, or if different stone materials are mixed to achieve a particular color or effect, the composition of the starting granulated material may be pre-arranged by the application of one of the usual formula for calculating the composition and particle-size distribution used in the field of cementitious products with reference to the inert component.

Examples of these formulae are Fuller Thompson's formula, or Bolomey's formula For the Fuller-Thompson formula, see N. B. Fuller, S. E. Thompson, Transactions ASCE, 59, 67 (1907). For Bolomey's formula, see J. Bolomey, Revue Mater, Costr. Trav. Publ., ed. C, page 147 (1947) as regards the Bolomey's formula, and these are discussed, for example, in M. Collepardi, Scienza e tecnologia del calcestruzzo, (Science and Technology of Concrete) pp. 292-303, editor Hoepli.

Once the starting granulated material and its composition and particle-size distribution have been identified, its void fraction can be calculated, for example, by formula 7.12 of the text indicated above.

The quantity of cementitious binding mix which is theoretically sufficient to fill the voids and interstices can be identified upon the basis of this void fraction. Those skilled in the art are familiar with the concept and it is discussed in detail in U.S. Pat. No. 6,355,191. In preferred embodiments the quantity of cementitious matrix used will be slightly in excess of the theoretical amount typically about 10% more than the theoretical amount.

The relative amount of natural aggregate in the composite material may vary depending upon the end use of the product. In most instances the natural aggregate will comprise from about 65% to about 85% by weight of the total composition. In preferred embodiments the natural aggregate will comprise from about 70% to about 75% by weight of the total composition.

In addition to the natural aggregate, a filler may be added to the aggregate and binder mixture. The filler may encompass any traditional material added to cementitious mixtures to add bulk and strength. Common fillers suitable for use with the invention include fumed silica, sand, clay, fly ash, broken ceramics, mica, silicate flakes, broken glass, glass beads, glass spheres, mirror fragments, steel grit, aluminum grit, carbides, plastic beads, pelletized rubber, ground polymer composites (e.g., acrylics encasing copper filings), wood chips, sawdust, paper laminates, pigments, colorants, and a mixture thereof.

The relative amount of filler used in the practice of the invention is also variable and depends upon the ultimate end use of the product. Fillers such as colorants are often added to the mixture to aid in achieving a uniform surface appearance. In fact, colorants often provide a useful carrier for other fillers and additives such as UV stabilizers which are commonly added to compositions destined for outdoor applications. Given the wide variety of fillers that may be used in the practice of the invention the quantity of filler in the overall composition can vary from 0% or a miniscule amount to about 12% by weight. The filler should not be present in amounts sufficient to reduce the effectiveness of the ultimate end product. Those skilled in the art of the artificial stone processes know the various considerations that govern the use of fillers in this process.

The method according to the invention also comprises the step of preparing a cementitious matrix comprising a water and cement slurry.

In preferred embodiments, the cementitious matrix is made from about equal parts, by volume, of cement and water. This mixture equates to a mixture having about 0.32 parts by weight of water relative to the weight of cement. In practice the cementitious matrix may have a water content of from about 0.25 to about 0.36 parts by weight relative to the weight of cement, preferably from about 0.28 to about 0.32 parts by weight. The cementitious matrix is preferably supplemented with a quantity of a known plasticizing additive for cementitious slurries such that, when the mix is poured onto a surface in order to carry out a “mini slump test”, it has a fluidity such that the mix is arranged in a very thin layer with a roundish shape having a diameter of about 20 cm and there is no apparent separation between the water and the cement with the deposition of the cement in the bottom of the mold and the appearance of the water on the surface. The cementitious matrix comprises from about 15% to about 35% by weight of the total composition, more preferably from about 20% to about 30% by weight of the total composition.

The expression “mini slump test” means the simplified form of the slump test according to the method defined by the UNI 9418 standards. This test is discussed in more detail in U.S. Pat. No. 6,355,191.

The method of the present invention continues with intimate mixing of the aggregate and the cementitious matrix. The quantity of cementitious matrix used is slightly in excess of the calculated theoretical void fraction of the granulated material. This excess does not have to be such as to lead, upon completion of the method, to the formation of an independent layer constituted by cement alone on one of the two faces of the product. In practice, the excess is normally of the order of 10% of the initial volume of cementitious binding mix related to the total volume of the mixture of granulated material and cementitious binding mix.

The mixing can be carried out under vacuum. Applying a vacuum is often desirable under certain circumstances (e.g., when the final product has a thickness greater than about 5 cm) and is preferred in most applications. If a vacuum is utilized, it should be a controlled vacuum and applied at a level that will not cause the water in the cementitious matrix to boil. Vacuums below about 70 mm Hg are preferred in this step.

The method further comprises the step of adding an antimicrobial agent to the aggregate and cementitious matrix. It is possible to add the antimicrobial by adding a charge of liquid antimicrobial during the water addition stage or as a powder during the dry blending of the cement.

Suitable antimicrobial agents that can be utilized in the practice of the invention include organic and inorganic antimicrobial agents. As will be readily apparent to one of skill in the art, a variety of organic antimicrobial agents are known including, for example, chlorhexidine, alexidine, cetyl pyridinium chloride, benzalkonium chloride, benzethonium chloride, cetalkonium chloride, cetrimide, cetrimonium bromide, glycidyl trimethylammonium chloride, stearalkonium chloride, hexetidine, triclosan and triclocarban. A preferred class of antimicrobial agents for use in the present invention is quaternary ammonium compounds, including but not limited to the following compounds:

Fluoride:
Tetra-n-butylammonium Fluoride, Tetraethylammonium Fluoride

Chloride:
Acetylcholine Chloride, (3-Acrylamidopropyl)trimethylammonium Chloride, Benzalkonium Chloride, Benzethonium Chloride, Benzoylcholine Chloride, Benzylcetyldimethylammonium Chloride, N-Benzylcinchonidinium Chloride, N-Benzylcinchoninium Chloride, Benzyldimethylphenylammonium Chloride, Benzyldimethylstearylammonium Chloride, N-Benzylquinidinium Chloride, N-Benzylquininium Chloride, Benzyltri-n-butylammonium Chloride, Benzyltriethylammonium Chloride, Benzyltrimethylammonium Chloride, Carbamylcholine Chloride, DL-Carnitine Hydrochloride, Chlorocholine Chloride, (3-Chloro-2-hydroxy-n-propyl)trimethylammonium Chloride, Choline Chloride, n-Decyltrimethylammonium Chloride, Diallyldimethylammonium Chloride, Dichloromethylenedimethyliminium Chloride, Dimethyldistearylammonium Chloride, n-Dodecyltrimethylammonium Chloride, Girard's Reagent T, n-Hexadecyltrimethylammonium Chloride, Hexamethonium Chloride, Lauroylcholine Chloride, Methacholine Chloride, Methacroylcholine Chloride, (2-Methoxyethoxymethyl)triethylammonium Chloride, [bgr]-Methylcholine Chloride, Methyltriethylammonium Chloride, Myristoylcholine Chloride, n-Octyltrimethylammonium Chloride, Phenyltriethylammonium Chloride, Phenyltrimethylammonium Chloride, Phosphocholine Chloride Calcium Salt, Phosphocholine Chloride Sodium Salt, Succinylcholine Chloride, Tetra-n-amylammonium Chloride, Tetra-n-butylammonium Chloride, Tetradecyldimethylbenzylammonium Chloride, n-Tetradecyltrimethylammonium Chloride, Tetraethylammonium Chloride, Tetramethylammonium Chloride, Trimethyl[2,3-(dioleyloxy)propyl]ammonium Chloride, Trimethylstearylammonium Chloride, Trioctylmethylammonium Chloride, Tri-n-octylmethylammonium Chloride,

Bromide:
Acetylcholine Bromide, Benzoylcholine Bromide, Benzyltri-n-butylammonium Bromide, Benzyltriethylammonium Bromide, Bromocholine Bromide, Cetyldimethylethylammonium Bromide, Choline Bromide, Decarrethonium Bromide, n-Decyltrimethylammonium Bromide, Didecyldimethylammonium Bromide, Dilauryldimethylammonium Bromide, Dimethyldimyristylammonium Bromide, Dimethyldioctylammonium Bromide, Dimethyldipalmitylammonium Bromide, Dimethyldistearylammonium Bromide, n-Dodecyltrimethylammonium Bromide, (Ferrocenylmethyl)dodecyldimethylammonium Bromide, (Ferrocenylmethyl)trimethylammonium Bromide, n-exadecyltrimethylanmonium Bromide, Hexamethonium Bromide, Hexyldimethyloctylammonium Bromide, n-Hexyltrimethylammonium Bromide, Methacholine Bromide, Neostigmine Bromide, n-Octyltrimethylammonium Bromide, Phenyltrimethylammonium Bromide, Stearyltrimethylammonium Bromide, Tetra-n-amylammonium Bromide, Tetra-n-butylammonium Bromide, Tetra-n-decylammonium Bromide, n-Tetradecyltrimethylammonium Bromide, Tetraethylammonium Bromide, Tetra-n-heptylammonium Bromide, Tetra-n-hexylammonium Bromide, Tetramethylammonium Bromide, Tetra-n-octylammonium Bromide, Tetra-n-propylammonium Bromide, 3-(Trifluoromethyl)phenyltrimethylammonium Bromide, Trimethylvinylammonium Bromide, Valethamate Bromide

Iodide:
Acetylcholine Iodide, Acetylthiocholine Iodide, Benzoylcholine Iodide, Benzoylthiocholine Iodide, Benzyltriethylammonium Iodide, n-Butyrylcholine Iodide, n-Butyrylthiocholine Iodide, Decamethonium Iodide, N,N-Dimethylmethyleneammonium Iodide, Ethyltrimethylammonium Iodide, Ethyltri-n-propylammonium Iodide, (Ferrocenylmethyl)trimethylammonium Iodide, (2-Hydroxyethyl)triethylammonium Iodide, [bgr]-Methylcholine Iodide, O-[bgr]-Naphthyloxycarbonylcholine Iodide, Phenyltriethylammonium Iodide, Phenyltrimethylammonium Iodide, Tetra-n-amylammonium Iodide, Tetra-n-butylammonium Iodide, Tetraethylammonium Iodide, Tetra-n-heptylammonium Iodide, Tetra-n-hexylammonium Iodide, Tetramethylammonium Iodide, Tetra-n-octylammonium Iodide, Tetra-n-propylammonium Iodide, 3-(Trifluoromethyl)phenyltrimethylammonium Iodide.

Hydroxide:
Benzyltriethylammonium Hydroxide, Benzyltrimethylammonium Hydroxide, Choline, n-Hexadecyltrimethylammonium Hydroxide, Phenyltrimethylammonium Hydroxide, Sphingomyelin, Tetra-n-butylammonium Hydroxide, Tetra-n-decylanmonium Hydroxide, Tetraethylammonium Hydroxide, Tetra-n-hexylammonium Hydroxide, Tetramethylammonium Hydroxide, Tetra-n-octylammonium Hydroxide, Tetra-n-propylammonium Hydroxide, 3-(Trifluoromethyl)phenyltrimethylammonium Hydroxide.

Others:
Acetylcholine Perchlorate, Benzyltrimethylammonium Dichloroiodate, Benzyitrimethylammonium Tetrachloroiodate, B enzyltrimethylammonium Tribromide, Betaine, Betaine Hydrochloride, Bis(tetra-n-butylammonium) Dichromate, Bis(tetra-n-butylammonium) Tetracyanodiphenoquinodimethanide, L-Carnitine, 3-[(3-Cholamidopropyl)dimethylammonio]-1-propanesulfonate, Denatonium Benzoate, n-Dodecyldimethyl(3-sulfopropyl)ammonium Hydroxide, Inner Salt, N-Fluoro-N′-(chloromethyl)triethylenediamine Bis(tetrafluoroborate), n-Hexadecyltrimethylammonium Hexafluorophosphate, n-Hexadecyltrimethylammonium Perchlorate, n-Hexadecyltrimethylammonium Tetrafluoroborate, (Methoxycarbonylsulfarnoyl)triethylammonium Hydroxide, Inner Salt, Neostigmine Methyl Sulfate, n-Octadecyldimethyl(3-sulfopropyl)ammonium Hydroxide, Inner Salt, Phenyltrimethylammonium Tribromide, Propionyl choline p-Toluenesulfonate, Tetra-n-butylammonium Azide, Tetra-n-butylammonium Bifluoride, Tetra-n-butylammonium Borohydride, Tetra-n-butylammonium Bromodiiodide, Tetra-n-butylammonium Dibromoaurate, Tetra-n-butylammonium Dibromochloride, Tetra-n-butyl ammonium Dibromoiodide, Tetra-n-butylammonium Dichloroaurate, Tetra-n-butylammonium Dichlorobromide, Tetra-n-butylammonium Difluorotriphenylsilicate, Tetra-n-butylammonium Difluorotriphenylstannate, Tetra-n-butylammonium Dihydrogentrifluoride, Tetra-n-butylammonium Diiodoaurate, Tetra-n-butylammonium Hexafluorophosphate, Tetra-n-butylammonium Hydrogensulfate [for Ion-Pair Chromatography], Tetra-n-butylammonium Hydrogensulfate, Tetra-n-butylam monium Perchlorate, Tetra-n-butylammonium Perrhenate, Tetra-n-butylammonium Phosphate, Tetra-n-butylammonium Salicylate, Tetra-n-butylammonium Tetrafluoroborate, Tetra-n-butylammonium Tetraphenylborate, Tetra-n-butylammonium Thiocyanate, Tetra-n-butylammonium Tribromide, Tetra-n-butylammonium Triiodide, Tetraethylammonium Borohydride, Tetraethylammonium Perchlorate, Tetraethylammonium Tetrafluoroborate, Tetraethylammonium p-Toluenesulfonate, Tetraethylammonium Trifluoromethanesulfonate, Tetramethylammonium Acetate, Tetramethylammonium Borohydride, Tetramethylammonium Hexafluorophosphate, Tetramethylammonium Hydrogensulfate, Tetramethylammonium Perchlorate, Tetramethylammonium Sulfate, Tetramethylammonium Tetrafluoroborate, Tetramethylammonium p-Toluenesulfonate, Tetramethylammonium Triacetoxyborohydride, Tetra-n-propylammonium Perruthenate, Trifluoromethanesulfonic Acid Tetra-n-butylammonium Salt.

Triclosan, zinc pyrithione, tolyl diiodomethyl sulfone, sodium pyrithione, ortho-phenylphenol, sodium ortho-phenylphenol, iodo-2-propynyl butylcarbamate, poly[oxyethylene(dimethyliminio) ethylene(dimethyliminio)ethylene chloride], 10, 10′-oxybis-10H-Phenoxarsine, propiconazole, tebuconazole, azole, bethoxazin, oxathiazine, chlorothalonil, thiabendazole, polyhexamethylene biguanide, and 1,3,5-triazine-1,3,5-(2H,4H,6H)-triethanol, isothiazalinones, triazine diamine, and a mixture thereof are among the preferred antimicrobial agents suitable for use in the present invention.

Tolyl diiodomethyl sulfone is commercially available as MICROBAN ADDITIVE AF™ from Microban Products Company of Huntersville, N.C. Triclosan is commercially available as MICROBAN ADDITIVE B™ from Microban Products Company of Huntersville, N.C. Zinc pyrithione is commercially available as MICROBAN ADDITIVE ZO1™ from Microban Products Company of Huntersville, N.C. Isothiazalinones such as Butyl-BIT, DCOIT and OIT are commercially available as MICROBAN ADDITIVE LB3™, MICROBAN ADDITIVE LB5™, and MICROBAN ADDITIVE LB6™, respectively, from Microban Products Company of Huntersville, N.C. The above antimicrobials are commercially available from Microban Products Company of Huntersville, N.C. as well as other suppliers.

Similarly, suitable inorganic antimicrobial agents include any of the known metal salts and ceramics. Such metal salts include salts of silver, copper, zinc, mercury, tin, lead, bismuth, barium, cadmium, chromium, and a mixture thereof. Particularly preferred metal salts include silver acetate, silver benzoate, silver carbonate, silver iodate, silver iodide, sliver lactate, silver laurate, silver nitrate, silver oxide, silver palmitate, silver sulfadiazine, zinc oxide, barium metaborate, and zinc metaborate. Antimicrobial silver salts are particularly preferred.

Antimicrobial metal ceramics suitable for use in the practice of the invention include but are not limited to zeolites, glasses, hydroxyapatite, zirconium phosphates or other ion-exchanging ceramics. Examples of silver containing ceramics include lonpure WPA, lonpure ZAF, and lonpure IPL from Ishizuka Glass Company and Ciba B5000 and Ciba B7000 from Ciba Specialty Chemicals.

The type and quantity of the antimicrobial agent in the composite structural material may vary depending upon the type and quantity of natural aggregate, the cementitious matrix, any filler, or other additives found in the composite material. The primary guideline for determining the necessary quantity of antimicrobial agent is that enough of the agent should be added to the composition to provide a commercially acceptable degree of efficacy against the microbe of concern.

In preferred embodiments the antimicrobial agent or agents should be present in the composition at a level of at least 500 ppm based upon the total weight of the composition. Cost factors typically establish the upper limit of the quantity of antimicrobial agent at about 1% by weight (i.e., 10,000 ppm). In most instances, the antimicrobial agent concentrations in the final product will be from about 100 ppm to about 10,000 ppm, most preferably from about 500 ppm to about 1500 ppm based upon the weight of the cured product.

In particularly preferred embodiments the antimicrobial agent is triclosan which is present in the composition in a concentration from about 800 ppm to about 5000 ppm.

In a further particularly preferred embodiment the antimicrobial agent is a metal. Silver is a particularly preferred metal and may be present as a free ion or in a matrix (e.g., zeolite or glass matrix). In this embodiment the silver is present in the composition in a concentration from about 100 ppm to about 10,000 ppm, more preferably from about 500 ppm to about 1500 ppm.

It should be understood that in certain situations the preferred type and quantity of antimicrobial agent may deviate from those presented herein. Those skilled in the art, however, should be able to take the teachings of this invention and make the necessary adjustments without undue experimentation.

The antimicrobial agent may be added to the composition in several ways. The particular method of adding the antimicrobial agent will depend upon the overall process and the equipment used. In general, however, the antimicrobial agent may be added in one of two ways—directly or via a carrier.

For example, the antimicrobial agent can be added directly to the aggregate/cementitious mixture before the mixture is placed in the mold. Alternatively, the antimicrobial agent could be added during preparation of the cementitious matrix. Premixing the antimicrobial agent (e.g., triclosan) with the cement prior to adding water would be an example. The powdered form of triclosan works well when added directly to the aggregate/cementitious mixture. Direct addition of metal antimicrobial agents to the aggregate/cemerititious mixture has also been shown to work well.

Alternatively, one could prepare a concentrated antimicrobial agent masterbatch which is then fed into the process at the appropriate point. An example of such a masterbatch would be to mix the antimicrobial agent with a colorant. Masterbatches of triclosan and colorant have historically worked well in this regard.

The method further comprises the step of spreading the resulting mixture in a mold or similar forming device to form a layer having a desired thickness. The spreading step is preferably done under vacuum if the mixing has taken place under vacuum. The thickness of the layer can range from less than a millimeter to several centimeters. Thicknesses between about 15 and about 20 millimeters are preferred for most end uses.

Once the mixture of aggregate and cementitious matrix is spread in a forming device the spread mixture is subjected to a very high vacuum for a period which is very short but long enough to bring about substantially complete deaeration of any interstices and to remove any air remaining incorporated in the starting mixture. In preferred embodiments the vacuum should be no less than 40 mm Hg.

This deaeration step should be very short and, in experimental tests it was found that it should preferably last no longer than 20 seconds. This short duration is necessary to prevent the water from boiling. Bubbles can cause imperfect compaction which is detrimental to the mechanical properties of the product. For products having a thickness greater than 5 cm longer deaeration may be required.

Upon completion of the deaeration step, the mold is subjected to vibration at a predetermined frequency, preferably from about 2000 to about 4800 cycles/min for a duration of between a few seconds to several minutes, usually less than 3 minutes. The mixture is preferably kept under vacuum, but at a level that is lower than that of previous step. In the case of slabs having thickness less than 5 cm the application of the vibratory motion should last for at around 60 seconds. Additional information regarding the vibration step may be found in U.S. Pat. No. 6,355,191.

After vibration and deaeration, the forming device is transferred to a setting and initial curing section.

In most instances setting and initial hardening occurs about 8 hours after vibration. Complete hardening to an extent sufficient for the mechanical removal of the product from the forming device generally occurs within 24 hours.

After the product is removed from the forming device it is stored to cure. For best results steps should be taken to prevent the evaporation of water from the curing product. Covering or enclosing the product in a waterproof material can prevent such evaporation.

The curing step preferably lasts at least 7 days. After this step it may be possible to cut or saw the product or carry out other finishing operations.

In the case of products having thickness greater than 5 cm, the initial curing step should last for at least 8 hours followed by a two-step final curing phase. The first step lasts about 7 days, in which the product is protected to avoid the water evaporation. The second step lasts for as long as needed for the completion of the curing.

Those skilled in the art realize that the curing step is not an “on and off” step but an event that occurs over a continuum. In fact, some curing can occur as early as the mixing step. For ease of discussion, however, the curing step is usually regarded as a separate step because it is normally the rate limiting step in a process and because the cure rate can be adjusted by adjusting process parameters.

Upon completion of the curing step the cured material is shaped into a finished product. Such products include tabletops, countertops, architectural facings, walkways, home furnishings, patio furniture, decorative stone, indoor and outdoor tile, flooring, mantles, bathroom fixtures, wall facings, cutting boards, sinks, showers, tubs, and imitation stone structures, among others.

As evident from the above discussion, the invention also encompasses a composite material having an appearance similar to that of natural stone comprising a natural aggregate, a cementitious matrix, and an antimicrobial agent. Fillers and other additives may also be present in the composite material.

Each of the above components and the relative amounts of each that are present in the composite material are discussed in connection with the process steps. Those skilled in the art can readily make the transition from the process discussion to the resulting end product. Accordingly, and for the sake of brevity, the discussions related to each of the material's components will not be repeated.

### EXAMPLES

Flooring tile samples were prepared in a batch by mixing a dry powder cement, natural aggregate, an antimicrobial agent (if indicated present below) and water in order to make a slurry. The amount of antimicrobial agent added was based upon the total weight of the batch. The slurry was molded. The tiles were set and cured.

The green cementitious flooring tiles comprising MICROBAN ADDITIVE AF™ at levels ranging from 500 ppm to 1000 ppm were tested and found to be very effective in preventing the growth of Aspergillus niger on the surfaces of the tiles. MICROBAN ADDITIVE AF™ is commercially available from Microban Products Company of Huntersville, N.C.

Green cementitious flooring tiles comprising MICROBAN ADDITIVE ZO1™ at levels ranging from 500 ppm to 1000 ppm were tested and found to offer poorer antifungal performance.

As the control, a green cementitious flooring tile comprising no antimicrobial additives was tested. The control was found to offer no resistance to fungus as it was freely populated by fungus.

All of the cementitious flooring tiles were tested using the AATCC 30 Part III Antifungal Test which is herein incorporated by reference. The test organism was Aspergillus niger, AATCC 6275. The incubation period was seven days. Prior to plating, the samples were neutralized by continuous soaking in 0.1 M HCl. This was completed because the intrinsic high pH of the cementitious substrate may itself disrupt fungal growth. The soaking also simulated an “aged” tile sample where the surface alkalinity has been neutralized with time by carbon dioxide in the air and ambient moisture. At each trial level, duplicate samples were plated to evaluate consistency and reproducibility of antifungal behavior.

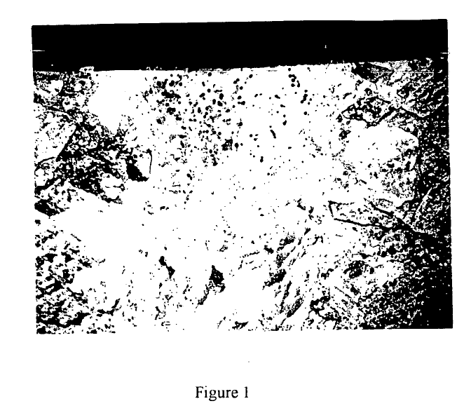

FIG. 1 is a photograph of a cementitious flooring tile sample as a control that was exposed to Aspergillus niger and had no antimicrobial additives in the sample. The control tile surface showed significant evidence of fungal growth and propagation. Each tiny dark spot in the photograph was a well-developed fungal fruiting structure. The fungal organism appeared to be healthy and networked. The control sample exhibited no antifungal resistance.

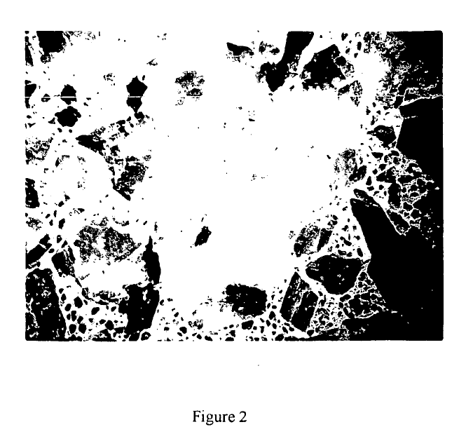

FIG. 2 is a photograph of a cementitious flooring tile sample comprising 500 ppm of MICROBAN ADDITIVE AF™. The surface of the cementitious flooring tile sample was extremely clean and showed no signs of fungal growth.

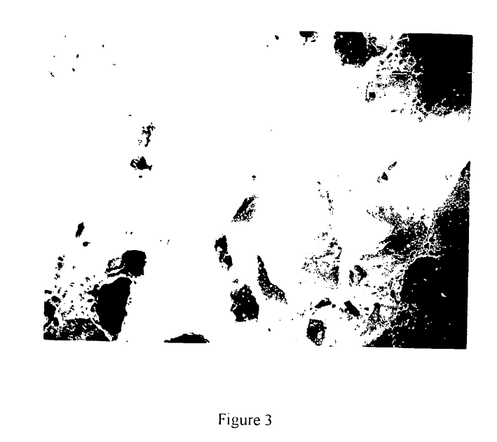

FIG. 3 is a photograph of a cementitious flooring tile sample comprising 750 ppm of MICROBAN ADDITIVE AF™. One of the replicates had a surface completely free of fungal growth while the other replicate showed some very minor signs of fungal growth. These dots may be attributed to incomplete mixing of MICROBAN ADDITIVE AF™ during the trial.

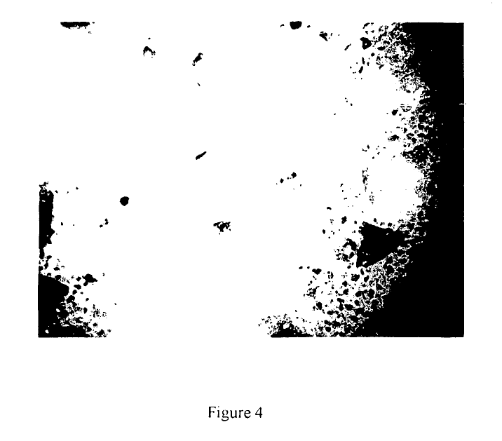

FIG. 4 is a photograph of a cementitious flooring tile sample comprising 1000 ppm of MICROBAN ADDITIVE AF™. Samples comprising 1000 ppm of MICROBAN ADDITIVE AF™ were completely free of fungal growth.

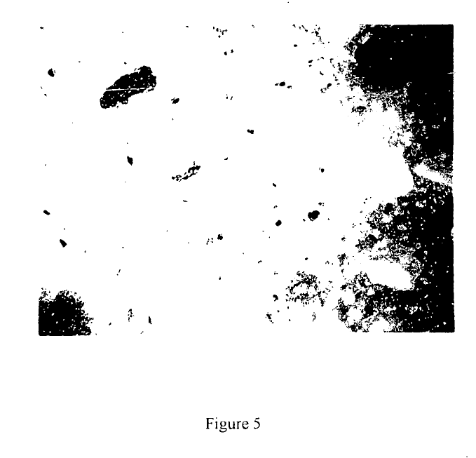

FIG. 5 is a photograph of a cementitious flooring tile sample comprising 500 ppm of MICROBAN ADDITIVE ZO1™. Under an optical microscope, the tile surfaces showed signs of fungal growth.

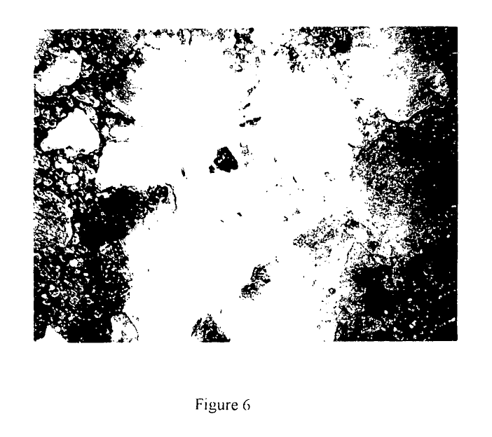

FIG. 6 is a photograph of a cementitious flooring tile sample comprising 750 ppm of MICROBAN ADDITIVE ZO1™. The tile surfaces showed signs of fungal growth.

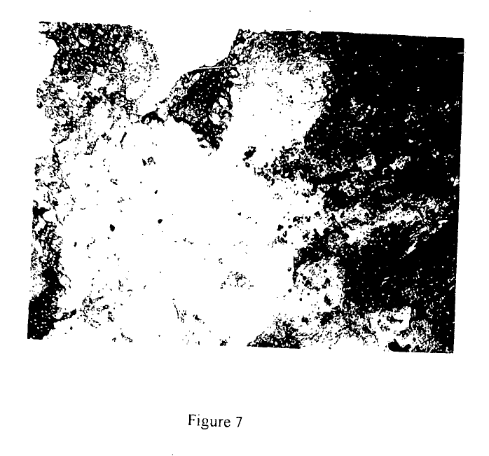

FIG. 7 is a photograph of a cementitious flooring tile sample comprising 1000 ppm of MICROBAN ADDITIVE ZO1™. One of the sample replicates comprising 1000 ppm of MICROBAN ADDITIVE ZO1™ had a relatively clean surface, but the replicate shown in FIG. 7 had spotted heavy fungal growth.

It will therefore be readily understood by those persons skilled in the art that the present invention is susceptible of broad utility and application. Many embodiments and adaptations of the present invention other than those herein described, as well as many variations, modifications and equivalent arrangements, will be apparent from or reasonably suggested by the present invention and the foregoing description thereof, without departing from the substance or scope of the present invention. Accordingly, while the present invention has been described herein in detail in relation to its preferred embodiment, it is to be understood that this disclosure is only illustrative and exemplary of the present invention and is made merely for purposes of providing a full and enabling disclosure of the invention. The foregoing disclosure is not intended or to be construed to limit the present invention or otherwise to exclude any such other embodiments, adaptations, variations, modifications and equivalent arrangements.

1. A composite material suitable for forming cementitious slab products having antimicrobial properties, said material comprising:
a natural aggregate,
a cementitious matrix, and
an antimicrobial agent.

2. The composite material according to claim 1, wherein said natural aggregate is selected from the group consisting of marble, granite, quartz, feldspar, marble, quartzite, and a mixture thereof.

3. The composite material according to claim 1, wherein said cementitious matrix comprises a filler selected from the group consisting of fumed silica, sand, clay, fly ash, cement, broken ceramics, mica, silicate flakes, broken glass, glass beads, glass spheres, mirror fragments, steel grit, aluminum grit, carbides, plastic beads, pelletized rubber, ground polymer composites, wood chips, sawdust, paper laminates, pigments, colorants, and a mixture thereof.

4. The composite material according to claim 1, wherein said natural aggregate comprises from about 65% to about 85% by weight of the total composition.

5. The composite material according to claim 4, wherein said natural aggregate comprises from about 70% to about 75% by weight of the total composition.

6. The composite material according to claim 1, wherein said cementitious matrix comprises from about 15% to about 35% by weight of the total composition.

7. The composite material according to claim 6, wherein said cementitious matrix comprises from about 20% to about 30% by weight of the total composition.

8. The composite material according to claim 1, wherein said cementitious matrix comprises a water and cement slurry having a water content of between about 0.25 to about 0.36 parts by weight relative to the weight of the cement.

9. The composite material according to claim 8, wherein said cementitious matrix further comprises a quantity of a plasticizing additive.

10. The composite material according to claim 1, wherein said natural aggregate has a particle size between about 0.1 mm to about 0.6 mm.

11. The composite material according to claim 8, wherein said cementitious matrix is present in an amount in excess of a theoretical amount of cementitious matrix required for the natural aggregate.

12. The composite material according to claim 11, wherein said excess amount is about 10%.

13. The composite material according to claim 1, wherein said antimicrobial agent is selected from the group consisting of organic and inorganic antimicrobial agents.

14. The composite material according to claim 1, wherein said antimicrobial agent is present in an amount from about 100 ppm to about 10,000 ppm.

15. The composite material according to claim 14, wherein said antimicrobial agent is present in an amount from about 500 ppm to about 1500 ppm.

16. The composite material according to claim 13, wherein said antimicrobial agent is an organic antimicrobial agent selected from the group consisting of quarternary ammonium compounds.

17. The composite material according to claim 16, wherein said quarternary ammonium compound has an unsaturated reactive group.

18. The composite material according to claim 1, wherein said antimicrobial agent is selected from the group consisting of triclosan, zinc pyrithione, tolyl diiodomethyl sulfone, sodium pyrithione, ortho-phenylphenol, sodium ortho-phenylphenol, iodo-2-propynyl butylcarbamate, poly[oxyethylene(dimethyliminio) ethylene(dimethyliminio)ethyl ene chloride], 10,10′-oxybis-10H-Phenoxarsine, propiconazole, tebuconazole, azole, bethoxazin, oxathiazine, chlorothalonil, thiabendazole, polyhexamethylene biguanide, and 1,3,5-triazine-1,3,5-(2H,4H,6H)-triethanol, isothiazalinones, triazine diamine and a mixture thereof.

19. The composite material according to claim 18, wherein said antimicrobial agent is triclosan.

20. The composite material according to claim 19, wherein said triclosan is present in an amount from about 100 ppm to about 10,000 ppm.

21. The composite material according to claim 18, wherein said antimicrobial agent is tolyl diiodomethyl sulfone.

22. The composite material according to claim 21, wherein said tolyl diiodomethyl sulfone is present in an amount from about 100 ppm to about 10,000 ppm.

23. The composite material according to claim 13, wherein said antimicrobial agent is an inorganic agent selected from the group consisting of metal salts, ceramics containing metals, zeolites containing metals, and a mixture thereof.

24. The composite material according to claim 23, wherein said antimicrobial agent is a metal salt selected from the group consisting of silver, copper, zinc, mercury, tin, lead, bismuth, barium, cadmium, chromium, and a mixture thereof.

25. The composite material according to claim 1, wherein said antimicrobial agent comprises silver.

26. The composite material according to claim 25, wherein said antimicrobial agent is selected from the group consisting of silver acetate, silver benzoate, silver carbonate, silver iodate, silver iodide, sliver lactate, silver laurate, silver nitrate, silver oxide, silver palmitate, silver sulfadiazine, ceramics comprising silver, zeolites comprising silver, and a mixture thereof.

27. The composite material according to claim 25, wherein said antimicrobial agent is present in an amount from about 100 ppm to about 10,000 ppm.

28. The composite material according to claim 1, wherein said antimicrobial agent is present in an amount sufficient to demonstrate commercially acceptable efficacy against a microbe of concern.

29. The composite material according to claim 1, further comprising a colorant.

30. A product comprising a natural aggregate, a cementitious matrix, and an antimicrobial agent.

31. The product according to claim 30, wherein the product is selected from the group consisting of a tile, a tabletop, a countertop, an architectural facing, a walkway, a home furnishing, patio furniture, decorative stone, flooring, a mantle, a wall facing, a bathroom fixture, and an imitation stone structure.

32. The product according to claim 30, wherein said antimicrobial agent is selected from the group consisting of quarternary ammonium compounds, quarternary ammonium compounds having an unsaturated reactive group, triclosan, zinc pyrithione, tolyl diiodomethyl sulfone, sodium pyrithione, ortho-phenylphenol, sodium ortho-phenylphenol, iodo-2-propynyl butylcarbamate, poly[oxyethylene(dimethyliminio) ethylene(dimethyliminio)ethylene chloride], 10, 10′-oxybis-10H-Phenoxarsine, propiconazole, tebuconazole, azole, bethoxazin, oxathiazine, chlorothalonil, thiabendazole, polyhexamethylene biguanide, and 1,3,5-triazine-1,3,5-(2H,4H,6H)-triethanol, isothiazalinones, triazine diamine and a mixture thereof.

33. A method of making a cementitious product having antimicrobial properties, the method comprising:
obtaining a natural aggregate;
preparing a cementitious matrix comprising a water and cement slurry and a plasticizing additive;
mixing the natural aggregate and the cementitious matrix;
adding an antimicrobial agent to the aggregate and cementitious matrix;
spreading the mixture of aggregate, cementitious matrix, and antimicrobial agent in a forming device;
deaerating the spread mixture of aggregate, cementitious matrix, and antimicrobial agent by placing the spread mixture under a vacuum;
applying a vibratory motion to the deaerated mixture while the deaerated mixture is under a vacuum; and
curing the deaerated spread mixture to form a cementitious product.

34. The method according to claim 33, wherein the natural aggregate comprises from about 65% to about 85% by weight of the total mixture.

35. The method according to claim 34, wherein the natural aggregate comprises from about 70% to about 75% by weight of the total mixture.

36. The method according to claim 33, wherein the natural aggregate comprises quartz, granite, feldspar, marble, quartzite, or a mixture thereof.

37. The method according to claim 33, further comprising combining the natural aggregate with a filler selected from the group consisting of fumed silica, sand, clay, fly ash, cement, broken ceramics, calcium carbonate, mica, silicate flakes, broken glass, glass beads, glass spheres, mirror fragments, steel grit, aluminum grit, carbides, plastic beads, pelletized rubber, ground polymer composites, wood chips, sawdust, paper laminates, pigments, colorants, and a mixture thereof.

38. The method according to claim 33, wherein the antimicrobial agent is added to the cement prior to forming the cementitious matrix.

39. The method according to claim 33, wherein the natural aggregate has an average particle size of from about 0.1 mm to about 0.6 mm.

40. The method according to claim 33, wherein the cementitious matrix has a water content of from about 0.25 to about 0.36 parts by weight relative to the weight of the cement.

41. The method according to claim 33, wherein the cementitious matrix is present in an amount in excess of a theoretical amount of cementitious matrix required for the natural aggregate.

42. The method according to claim 33, wherein deaerating comprises placing the spread mixture under a vacuum of not less than about 40 mm Hg.

43. The method according to claim 42, wherein the vacuum is carried out for a period of from about 10 seconds to about 600 seconds.

44. The method according to claim 33, wherein the vibratory motion occurs with a frequency of from about 2000 cycles per minute to about 4800 cycles per minute at a vacuum of from about 70 mm Hg to about 80 mm Hg for at least 10 seconds.

45. The method according to claim 33, wherein spreading the mixture comprises spreading the mixture such that the cementitious product has a thickness not less than about 5 cm.

46. The method according to claim 33, wherein said antimicrobial agent is selected from the group consisting of organic and inorganic antimicrobial agents.

47. The method according to claim 46, wherein the antimicrobial agent is organic and is present in the aggregate and cementitious matrix in an amount from about 100 ppm to about 10,000 ppm.

48. The method according to claim 33, wherein the antimicrobial agent is present in the cementitious matrix prior to mixing the cementitious matrix with the aggregate.

49. The method according to claim 46, wherein the antimicrobial agent is an organic antimicrobial agent and is selected from the group consisting of quarternary ammonium compounds and quarternary ammonium compounds having an unsaturated reactive group.

50. The method according to claim 33, wherein said antimicrobial agent is selected from the group consisting of triclosan, zinc pyrithione, tolyl diiodomethyl sulfone, sodium pyrithione, ortho-phenylphenol, sodium ortho-phenylphenol, iodo-2-propynyl butylcarbamate, poly[oxyethylene(dimethyliminio) ethylene(dimethyliminio)ethylene chloride], 10,10′-oxybis-10H-Phenoxarsine, propiconazole, tebuconazole, azole, bethoxazin, oxathiazine, chlorothalonil, thiabendazole, polyhexamethylene biguanide, and 1,3,5-triazine-1,3,5-(2H,4H,6H)-triethanol, isothiazalinones, triazine diamine and a mixture thereof.

51. The method according to claim 50, wherein the antimicrobial agent is triclosan and is present in the overall composition in an amount from about 100 ppm to about 10,000 ppm.

52. The method according to claim 46, wherein the antimicrobial agent is an inorganic agent selected from the group consisting of metal salts, ceramics comprising metals, zeolites comprising metals, and a mixture thereof.

53. The method according to claim 52, wherein the antimicrobial agent is a metal salt selected from the group consisting of silver, copper, zinc, mercury, tin, lead, bismuth, barium, cadmium, chromium, and a mixture thereof.

54. The method according to claim 52, wherein said antimicrobial agent is silver zeolite and is present in an amount from about 100 ppm to about 10,000 ppm.

55. The method according to claim 33, wherein said antimicrobial agent is present in an amount sufficient to demonstrate commercially acceptable efficacy against a microbe of concern.

56. The method according to claim 33, further comprising forming a finished product from the cementitious product.

57. The method according to claim 56, wherein the finished product is a tile, a tabletop, a countertop, an architectural facing, a walkway, a home furnishing, patio furniture, decorative stone, flooring, a mantle, a wall facing, a bathroom fixture, a cutting board, a sink, a shower, a tub, and an imitation stone structure.

58. The method according to claim 50, wherein the antimicrobial agent is tolyl diiodomethyl sulfone.

59. The method according to claim 58, wherein the tolyl diiodomethyl sulfone is present in an amount from about 100 ppm to about 10,000 ppm.
